(19) United States
(12) Patent Application Publication
(10) Pub. No.: US 2004/0120321 A1
(43) Pub. Date: Jun. 24, 2004

(54) Input buffered switches using pipelined simple matching and method thereof

(76) Inventors: Man Soo Han, Daejon (KR); Bong Tae Kim, Daejon (KR)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 10/699,402

(22) Filed: Oct. 31, 2003

(30) Foreign Application Priority Data
Dec. 20, 2002 (KR) 2002-81956

(51) Int. Cl. H04L 12/56

(52) U.S. Cl. 370/395.4; 370/412

(57) ABSTRACT

An input buffered switch having a competing chance for transferring a cell at every time slot. The input buffered switches using pipelined simple matching, includes: a plurality of input unit for sending a request in every time slot in case that each Virtual Output Queue (VOQ) has at least one cell and outputting the cell according to a grant signal to each VOQ; a scheduling unit for executing a contention process according to requests from each VOQ of a plurality of input unit, sending contention results to a plurality of input unit and sending switch operating information to a switching unit; and the switching unit for switching and outputting the cell received from a plurality of input unit according to the switch operating information from the scheduling unit.

### FIELD OF THE INVENTION

The present invention relates to an input buffered switch using pipelined simple matching (PSM) and method thereof; and, more particularly, to an input buffered switch using pipelined simple matching for transferring cells from each input to each output by successively sending requests to transfer cells to a plurality of sub-schedulers when an input module has at least one awaiting cell in a virtual output queue (VOQ).

### DESCRIPTION OF RELATED ARTS

In input-buffered switches, the Virtual-Output-Queue (VOQ) structure is used to overcome a problem associated with First-In-First-Out (FIFO) input queuing, which is called Head-Of-Line (HOL) blocking problem. Because of the problem above, a conventional input buffered switch dose not achieve 100% throughput and performance of input buffered switch can not be better than that of output buffered switch. In case of N×N switch, a switching speed of an input buffered switch is same with an operating speed of input/output ports, but the switching speed of output buffered switch should be N times of the operating speed of input/output ports. Therefore, the input buffered switch is more adequate to high speed switching than the output buffered switch even though the output buffered switch has high performance.

In order to solve the problem of the HOL blocking and enhance the performance, various methods are developed. One of those methods is a Virtual Output Queue (VOQ) method that uses a plurality of buffers per each output port of each input module.

An N×N switch to which the VOQ method is applied has N input modules and each of input modules has N queues. It becomes total N² input queues. Because each input transfers one cell to each output port of the input modules at each time slot, contention for choosing N input queues out of total N² input queues occurs. Typical scheduling methods for arbitrating contentions have been introduced such-as iterative SLIP (iSLIP), iterative round robin matching at U.S. Pat. No. 5,500,858, Parallel Iterative Matching (PIM) at U.S. Pat. No. 5,267,235, and Simple Matching Algorithm (SMA) by M. S. Han et al, at “Simple Matching Algorithm for input buffered switch with service class priority,” IEICE Transactions on Communications, Vol. E84-B, No. 11, pp. 3067-3071, 2001.

However, the methods above have drawbacks that arbitrating contention must be finished within the one time slot. As the speeds of input/output ports are increased, the time slot width is decreased. As the number of ports is increased, information volume is increased and it also makes difficult to finish arbitrating contention within the one time slot. Therefore, iSLIP, PIM, and SMA are not the adequate methods to arbitrate contention for a high speed and large capacity switch.

In order to overcome this problem, a Round Robin Greedy Scheduling (RRGS) at Korean patent application N.O. 1999-027469, the RRGS at Japan patent application N.O. 2000-174817 and “Flexible bandwidth allocation in high-capacity packet switches,” by A. Smiljanic, at IEEE/ACM Transactions on Networking, Vol. 10, No. 4, pp. 287-293, 2002) is suggested.

Hereinafter, the RRGS is explained in details as follows. At time slot t, a first input chooses a cell to be transferred at time slot t+N and send information including a destination of the chosen cell at the first input to a second input. At time slot t+1, the second input chooses a cell to be transferred at time slot t+N among cells that have different destinations from the chosen cell of the first input and sends information including destinations of the chosen cells at previous inputs to a third input. At time slot t+2, the third input determines a cell to be transferred using the same method mentioned above. This method proceeds until an N^{th} input determines a cell to be transferred at time slot t+N and all inputs transfer cells to each destination. Mean while, at time slot t+1, the first input chooses a cell to be transferred at time slot t+N+1 and send information including a destination of the chosen cell of the first input to the second input. The same method mentioned above continues to the last input and this pipelined method is operated repeatedly.

The RRGS method has been modified to enhance its performance according to implementation fields such as Variable Length Packet Switching at Japan Patent Application No. 2001-197064, Modified Method of Service Fairness at Japan Patent Application No. 1999-355382 and at Japan Patent Application No. 2000-055103, Multiplexed input in Input Buffered Switches at Japan Patent Application No. 2000-049903, Input scheduling of data transfer time at Japan Patent Application No. 2000-091336 and Pipelined method of subdividing N×N scheduling data into M×M scheduling data at Japan Patent Application No. 2000-302551.

These methods are in common that the cell to be transferred is chosen at a preceding input and then the cell to be transferred is chosen at the next input according to information including the destinations of the cells at the preceding inputs. This method proceeds until the last input chooses a cell to be transferred and the chosen cells are transferred simultaneously. Therefore, although certain cells are chosen already, they must wait until all inputs finish choosing the cells. Because of the reason above, cell latency varies excessively and it results in degradation of characteristics of mean delay and cell delay variance. Also, in the aspect of the implementation, if one of the inputs or one of transmission paths between inputs is out of order, scheduling and switching operations of whole switch stop working.

In order to solve the problem above, a Pipelined Maximal Matching (PMM) method, a pipeline-based approach for maximal-sized matching scheduling in input-buffered switches by E. Oki et al, at IEEE Communications Letters, Vol. 5, No. 6, pp. 263-265, 2001 is suggested.

An input buffered switch to which the PMM method is applied has a scheduler including a plurality of sub-schedulers. In each time slot, one sub-scheduler completes a contention process and another sub-scheduler begins a contention process. Also, every input sends the scheduling data of each time slot to each sub-scheduler that begins a contention process. Each sub-scheduler uses the scheduling data received from each input when its contention process was started. Therefore, the cell delay variance is minimized and the switch performance is enhanced because each input contends with the scheduling data of the same time.

The operation of a Pipelined Maximal Matching (PMM) method is explained in detail. A cell arrives at Virtual Output Queue (VOQ) of input module and a request counter increments on each cell arrival. In a time slot, the VOQ having at least one cell sends a request to a sub-scheduler only if the sub-scheduler starts the contention in the beginning of the time slot and the sub-scheduler can accepts the request. The requests counter decrements on each occurrence of sending a request from the VOQ. The sub-scheduler which received the request begins the contention process and the request remains in the sub-scheduler till the request wins for the transmission. Also, the sub-scheduler can accept only one request for each output destination. When a request is removed or it has no request for a destination, the sub-scheduler can accept a request for the destination. It takes K time slots to complete a contention process. The term “K” shows how many time slots are required to complete a contention process. To produce a scheduling result in each time slot, K must be same to the number of sub-schedulers. After the contention process, contention results are transferred to each input module. The sub-scheduler deletes the request when the request is granted for the transmission and then the sub-scheduler can accept another request. The contention results include the information of the granted VOQ and not-granted VOQ. The granted VOQ receives a grant signal and transfer its Head of Line (HOL) cell to the switch.

However, the Pipelined Maximal Matching (PMM) method has several drawbacks.

First, each VOQ needs a request counter and large number of bits is required for the request counters because of the worst case that a VOQ is full. Also, as the number of input/output ports increases, total number of request counters increases and it is complicated to implement the system with large number of request counters.

Second, each request is sent to only one sub-scheduler and it takes K time slots to finish contention process of each sub-scheduler. Because the request has only one chance of contention in K time slots, the efficiency of the PMM method above is degraded compared to the non-pipelined method.

Third, more than K sub-schedulers are necessary in actual implementation of PMM because transferring latency exists both in the process of sending request and sending back contention results to input modules.

FIG. 4 is a timing diagram showing why additional sub-schedulers are necessary to compensate the transferring latency between each input module and scheduler in a conventional Pipelined Maximal Matching (PMM) method.

Referring to FIG. 4, at a contention process 41, 3 time slots are required for a contention process and at time frames 40 and 42, 2 time slots are required for exchanging information between the input module and the sub-scheduler. A sub-scheduler 1 completes the contention process in the time slot 5 and ready to begin another contention process in the time slot 6. However, sub-scheduler 1 can not have another request until the sub-scheduler 1 sends a contention result to input module and input module sends another request to sub-scheduler 1. Because it takes 4 time slots to complete exchanging the information between the input module and the sub-scheduler, four sub-schedulers 4 to 7 are additionally used. Therefore, contention control process needs 7 sub-schedulers that include 3 sub-schedulers for actual contention process and 4 sub-schedulers for exchanging the information between the input module and the sub-scheduler.

### SUMMARY OF THE INVENTION

It is, therefore, an object of the present invention to provide an input buffered switch using pipelined simple matching (PSM) and a contention method for sending a request for transferring a cell subsequently at every time slot when each input module has at least one awaiting cell in a virtual output queue (VOQ). Mean while, the request for transferring the cell is canceled when the input module does not have an awaiting cell in the VOQ.

It is another object of the present invention to provide an input buffered switch using pipelined simple matching (PSM) and a contention method for sending the number of awaiting cells in the VOQ to the sub-scheduler that begins a contention process at every time slot.

In accordance with an aspect of the present invention, there is provided an input buffered switch using pipelined simple matching, including a plurality of input modules, each having a plurality of Virtual Output Queues (VOQs) for sending a request signal in every time slot when each VOQ has at least one cell, for outputting the cell according to a grant signal transmitted to each VOQ; a scheduler for executing a contention process according to the request signals from each VOQ of the plurality of input modules, sending a contention result to the plurality of input modules and sending switch operation information; and a switch for switching and outputting the cell received from the plurality of input modules responsive to the switch operation information from the scheduler.

In accordance with an aspect of the present invention, there is also provided an input buffered switches and its contention method using pipelined simple matching, comprising the steps of: a) sending requests from each VOQ that has at least one awaiting cell to a sub-scheduler that begins a contention process in a time slot; b) executing a contention process during a plurality of time slots according to the requests from each VOQ that has at least one awaiting cell in the sub-scheduler; c) sending a contention result to each input module from the sub-scheduler that finishes the contention process in a time slot; and d) transferring the cell to the switch according to the contention process.

### BRIEF DESCRIPTION OF THE DRAWINGS

The above and other objects and features of the present invention will become apparent from the following description of the preferred embodiments given in conjunction with the accompanying drawings, in which:

FIG. 1 is a diagram of an input buffered switch using a simple pipelined method in accordance with the present invention;

FIG. 2 is a diagram showing a scheduler of an input buffered switch in accordance with the present invention;

FIG. 3 is a timing diagram showing an operating sequence of each sub-scheduler in an input buffered switch in accordance with the present invention;

FIG. 4 is a timing diagram showing why additional sub-schedulers are necessary to compensate the transferring latency between each input module and scheduler in the prior Pipelined Maximal Matching (PMM) method;

FIG. 5 is a timing diagram showing that although transfer latency exists between each input module and scheduler, additional sub-schedulers are not required in the input buffered switch of the present invention;

FIG. 6 is a timing diagram showing that at least one sub-scheduler must not grant to the same request in an input buffered switch in accordance with the present invention;

FIG. 7 is a graph of computer simulation results showing that mean delays of the present invention is compared with that of PMM method when a contention process is performed for 2 time slots;

FIG. 8 is a graph of computer simulation results showing that mean delays of the present invention is compared with that of PMM method when a contention process is performed for 4 time slots; and

FIG. 9 is a graph of computer simulation results showing that mean delays of the present invention is compared with that of PMM method when a contention process is performed for 6 time slots.

### DETAILED DESCRIPTION OF THE INVENTION

Other objects and aspects of the invention will become apparent from the following description of the embodiments with reference to the accompanying drawings, which is set forth hereinafter.

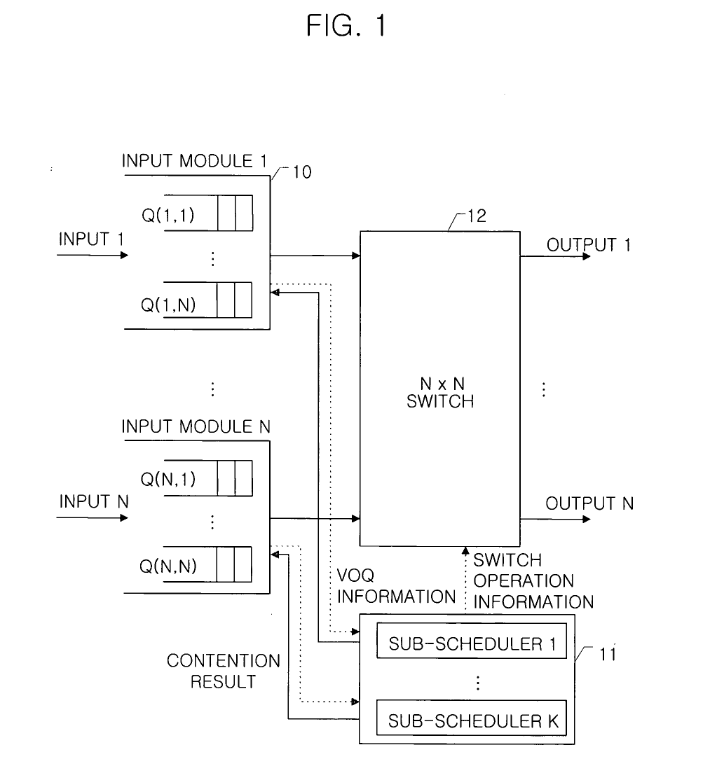

FIG. 1 is a diagram of an input buffered switch using a simple pipelined method in accordance with the present invention.

Referring to FIG. 1, the input buffered switch using the simple pipelined method includes a plurality of Virtual Output Queue (VOQ) in each input module for sending a request to transfer a cell to a scheduler 11 in every time slot when the VOQ has at least one awaiting cell; N input modules for outputting the cell that are granted to be transferred from the scheduler 11; a scheduler for executing a contention process according to the requests to transfer cells from each VOQ of N input modules 10 in order to send contention results to a plurality of input modules 10 and send switch operation information to an N×N switch 12; and an N×N switch 12 for switching and outputting the cell received from the N input modules 10 according to switch operation information from the scheduler 11.

Operation of the input buffered switch using the simple pipelined method is explained in details.

Input module i has N Virtual Output Queues (VOQ), Q(i,1) to Q(i,N) and if the destination of a cell is j, the cell is stored in Q(i,j). If a VOQ has at least one awaiting cell, the VOQ sends a request to a scheduler 11. The scheduler 11 chooses which VOQ transfers a cell according to the request signals and sends a grant signal to a selected VOQ. After a contention process in every time slot, the scheduler 11 sends contention results to each input module 10 in every time slot. Contention process must meet the condition that the input module 10 can transfer only one cell and each output can receive only one cell in each time slot.

N×N switch 12 receives the switch operation information according to the contention result in every time slot and transfers the cell transmitted from the input module 10 to a corresponding output. An N×N cross bar switch is used in accordance with a preferred embodiment of the present invention.

The scheduler 11 has K sub-schedulers and it takes K time slots for each sub-scheduler to complete the contention process. Each sub-scheduler has a different beginning time slot for the contention process and also a different finishing time slot for the contention process. One sub-scheduler begins a contention process and another sub-scheduler completes a contention process in a time slot. Each sub-scheduler executes the contention process according to the request signals at the beginning of the contention process and sends a contention result to each input module 10 at the end of the contention process.

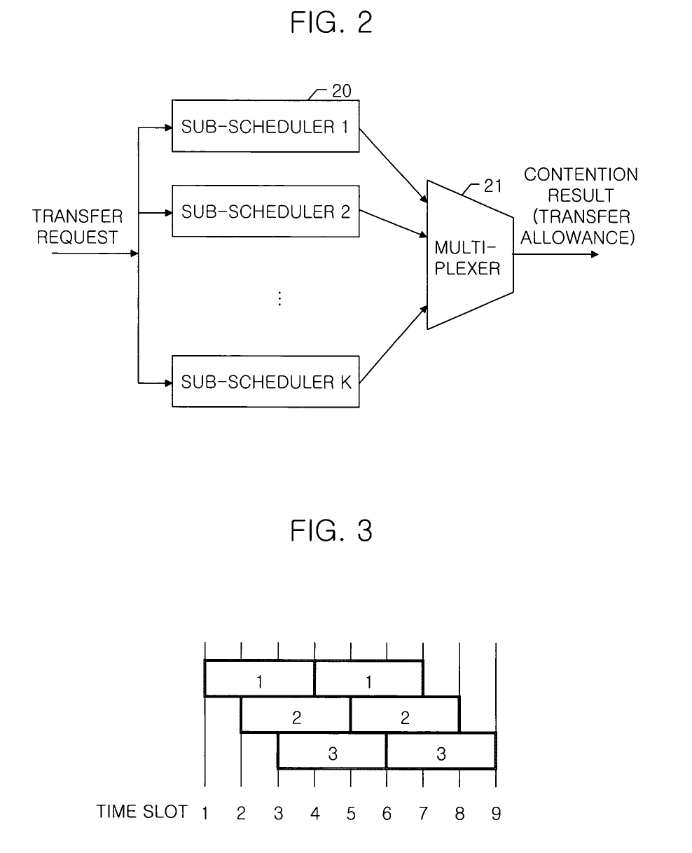

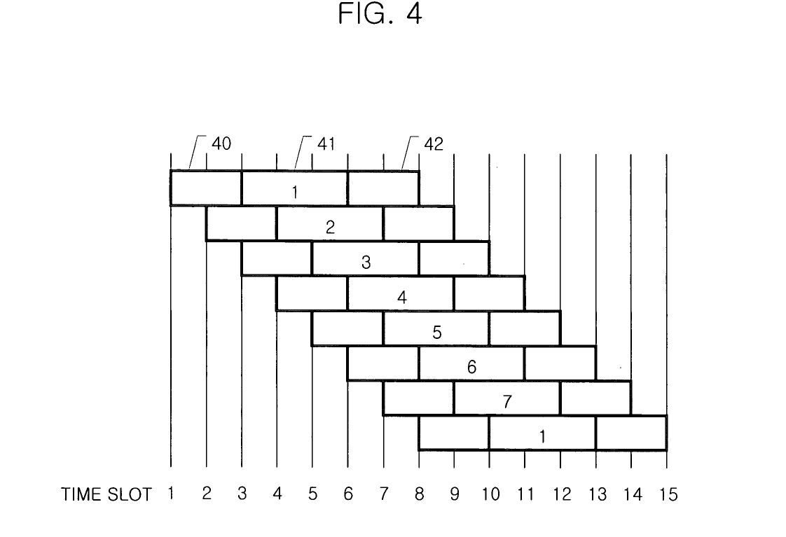

FIG. 2 is a diagram showing a scheduler of an input buffered switch in accordance with the present invention.

As shown in FIG. 2, request signals are sent to each sub-scheduler 20. The request signals compete in a sub-scheduler 20, and the contention results are multiplexed in a multiplexer 21 and transferred to each input module 10. Although each sub-scheduler can be implemented in the same structure of hardware, beginning and finishing time slot of contention process differ from each sub-scheduler. The request signal is sent to a sub-scheduler 20, but the sub-scheduler 20 does not recognize the request signal until the sub-scheduler 20 begins the contention process. The contention result from each sub-scheduler is sent to each input module 10 through the multiplexer 21. Each sub-scheduler can be implemented in a single chip or in a plurality of chips.

A pipelined simple matching (PSM) in an input buffered switch according to the present invention is explained in details as follows.

As described above, the scheduler has K sub-schedulers. Each sub-scheduler needs K time slots to complete the contention process. In each time slot, one sub-scheduler completes a contention process and another sub-scheduler begins a contention process. FIG. 3 is a timing diagram showing an operating sequence of each sub-scheduler in an input buffered switch in accordance with the present invention. It shows the operation of a pipelined method when the value K is 3. Also, each sub-scheduler has an independent contention process. Each Virtual Output Queue (VOQ) has a request counter and the number of cells that must be transferred is counted. However, unlike a Pipelined Maximal Method (PMM) which uses the request counters for each VOQ, the present invention only uses HOL information of VOQ cell.

Every VOQ having at least one awaiting cell sends a request signal to a sub-scheduler that begins a contention process at every time slot. Each sub-scheduler receives the request signal and operates the contention process during the K time slots according to the requests of when it started the contention process. The contention results are transferred to each input module 10 at the end of the contention process and the contention result includes information of granted VOQ and not-granted VOQ. The VOQ that received a granted signal, transfers the Head of Line (HOL) cell to a switch. When an empty VOQ receives a grant signal, the grant signal is ignored.

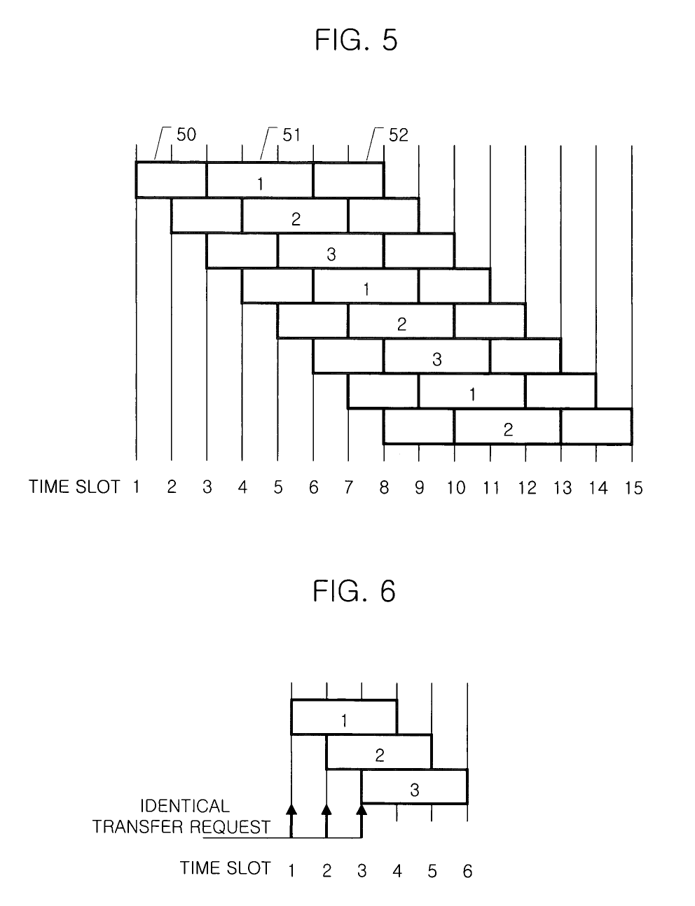

FIG. 5 is a timing diagram showing that although transfer latency exists while exchanging information between input module and scheduler, additional sub-schedulers are not required in the input buffered switch of the present invention.

Referring to FIG. 5, at a contention process 51, 3 time slots are required for a contention process and at time frames 50 and 52, 2 time slots are required for exchanging information between the input module and the sub-scheduler. A sub-scheduler 1 completes the contention process in the time slot 5 and is ready to begin another contention process in the time slot 6. Because unlike the PMM method, sub-scheduler 1 of the present invention does not need to know the prior contention result, sub-scheduler 1 can immediately begin the contention process. As shown in FIG. 5, only K sub-schedulers for the actual contention process are required in the present invention even if latency exists between the input module and the sub-scheduler.

The present invention can be enhanced by implementing several methods.

One of the methods to enhance the efficiency is giving different levels of priorities to each input module when each sub-scheduler is executing contention processes to a same output. In case that a VOQ has only one cell and sent a request signal to a sub-scheduler 1 for the first time, it takes 3 time slots to complete the contention process and the contention process is completed in the end of the time slot 3. However, the same VOQ sends a request signal to a sub-scheduler 2 in the beginning of a time slot 2 and to a sub-scheduler 3 in the beginning of time slot 3 successively. If the VOQ is granted from the sub-scheduler 1 at the end of time slot 3 and is granted from one of the sub-scheduler 2 or the sub-scheduler 3, the grant from the sub-scheduler 2 or the sub-scheduler 3 may be wasted. Contention efficiency can be enhanced if the sub-scheduler 2 or the sub-scheduler 3 of the example above grants other VOQ to transfer a cell.

FIG. 6 is a timing diagram showing that more than one sub-scheduler must not grant the same request in an input buffered switch in accordance with the present invention.

Referring to FIG. 6, each sub-scheduler must not transfer a grant signal to the same request. Therefore, each sub-scheduler gives priority to different input modules. For example, a sub-scheduler 1 gives priority to an input module 1, a sub-scheduler 2 gives priority to an input module 4, and a sub-scheduler 3 gives priority to an input module 8 for a contention process to an output 1. This mitigates the possibility that more than one sub-scheduler grants the same request.

Furthermore, another method can be implemented to the present invention to enhance the contention efficiency by giving a priority to the VOQ that has relatively large quantity of cells in a contention process to the same output.

Although pluralities of sub-schedulers send grant signals to one VOQ, if the VOQ has enough number of cells, grant signals may not be wasted. However, if a VOQ having the largest number of cells always has a higher priority, service fairness can not be guaranteed. Therefore, the priority must be given fairly. If the VOQ having the priority does not send a request, the priority must be given to the VOQ having a next level of priority. The priority is given by the number of awaiting cells in a VOQ.

If the contention process is executed according to the number of cells instead of HOL information, the Pipelined simple matching (PSM) is modified as follows.

Each VOQ sends the number of cells to each sub-scheduler that is beginning contention at every time slot and each sub-scheduler executes contention processes for K time slots by using the number of cells. The contention result of every time slot is sent from each sub-scheduler to each input module.

The performance of the present invention is explained by the computer simulation as following.

A 64×64 switch is used in the computer simulation. The traffic model of simulations is a uniform traffic, i.e., Bernoulli arrivals with destinations uniformly distributed over all outputs. The simulation was performed during 10⁶ time slots. The prior PMM method used an iSLIP algorithm in each sub-scheduler and the present invention of PSM method used a Simple Matching Algorithm (SMA) in each sub-scheduler. Different levels of priorities are given to each input modules in the SMA method.

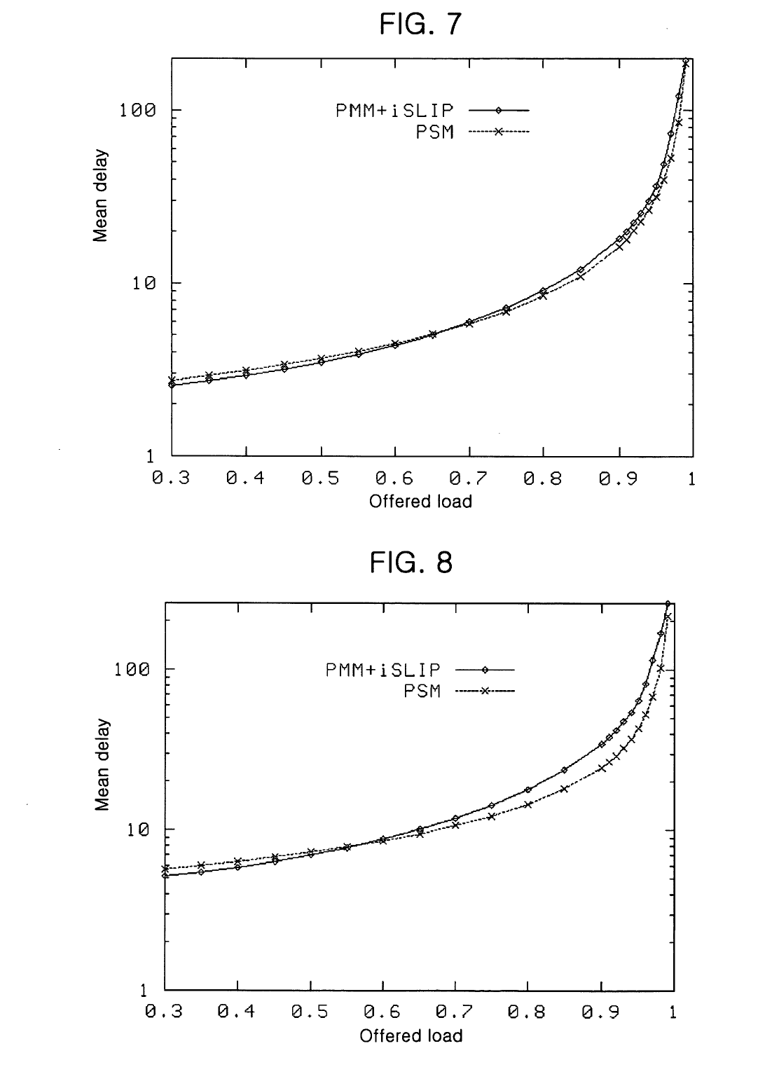

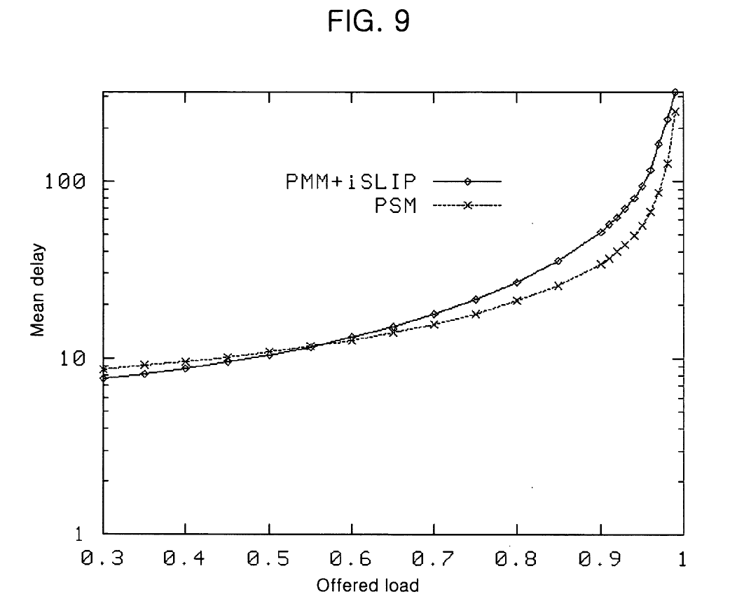

FIGS. 7 to 9 are graphs of computer simulation results showing that mean delays of the present invention is compared with that of the PMM method when a contention process is performed for 2 time slots, 4 time slots, and 6 time slots.

Referring to FIGS. 7 to 9, as the number of sub-scheduler, i.e., the number of time slots that are required for a contention process, is increased, the present invention outperforms the PMM method using the iSLIP in an aspect of mean delay under heavy traffics.

The present invention has the efficiencies as follows.

First, while the PMM method provides only one competing chance during the predetermined time slots because request is sent to only one sub-scheduler, the present invention provides the competing chance in every time slot because the present invention successively sends each request to all sub-schedulers to overcome the contention opportunity limitations of the PMM method. Therefore, the present invention has same competing chances as non-pipelined method and has more competing chances than that of the PMM method as much as the number of sub-scheduler.

Second, unlike the PMM method, the present invention can be implemented in a simple structure using only HOL information of VOQ by not using the request counters.

Third, unlike the PMM method, the present invention does not need additional sub-schedulers to compensate transfer latency between the input module and the scheduler. Because the present invention sends contention results to the sub-scheduler in regardless with transfer latency, the present invention uses smaller number of sub-schedulers than that of the PMM method.

Forth, the timing constraint becomes a major obstacle to build a large scale or high speed switch since as the switch size increases, the contention time is likely to take longer than a time slot or as the port speed increases, the time slot width decreases. Therefore, the present invention is a more adequate method for a high speed/large capacity switch than the PMM method.

While the present invention has been described with respect to certain preferred embodiments, it will be apparent to those skilled in the art that various changes and modifications may be made without departing from the scope of the invention as defined in the following claims.

What is claimed is:

1. An input buffered switch using pipelined simple matching, comprising:
a plurality of input means, each having a plurality of Virtual Output Queues (VOQs) for sending a request signal in every time slot when each VOQ has at least one cell, for outputting the cell according to a grant signal transmitted to each VOQ;
a scheduling means for executing a contention process according to the request signals from each VOQ of the plurality of input means, sending contention results to the plurality of input means and sending switch operation information; and
a switching means for outputting the cell received from the plurality of input means responsive to the switch operation information received from the scheduling means.

2. The apparatus as recited in claim 1, wherein the scheduling means includes:
a plurality of sub-scheduling means for executing a contention process for a plurality of time slots according to the request signals from each VOQ of the plurality of the input means in the manner that one sub-scheduler begins a contention process and another sub-scheduler finishes a contention process; and
a multiplexing means for multiplexing a contention result of each sub-scheduling means to the plurality of input means.

3. The apparatus as recited in claim 2, wherein the each sub-scheduling means gives priorities to each of the input means in case of the contention process to the same output.

4. The apparatus as recited in claim 1, wherein each VOQ sends the request signal at every time slot by sending the number of cells waiting in the VOQ to the scheduling means.

5. The apparatus as recited in claim 4, wherein the scheduling means includes:
a plurality of sub-scheduling means for executing the contention process for a plurality of time slots according to the request signals from each VOQ of the plurality of the input means in the manner that one sub-scheduler begins a contention process and another sub-scheduler finishes a contention process; and
a multiplexing means for multiplexing a contention result of each sub-scheduling means to the plurality of the input means.

6. The apparatus as recited in claim 5, wherein the each sub-scheduling means gives a priority to the VOQ that has the largest number of awaiting cells in the VOQ in case of the contention process to the same output.

7. The apparatus as recited in claim 5, wherein the each sub-scheduling means gives a priority to each VOQ in the contention process to the same output and gives a priority to a VOQ that has the largest number of awaiting cells in the VOQ when the VOQ having the priority does not send the request signal.

8. A contention method using pipelined simple matching in an input buffered switch, comprising the steps of:
a) at each VOQ that has at least one awaiting cell, sending a request signal to a sub-scheduling means that begins a contention process at every time slot;
b) at the sub-scheduling means, executing a contention process for a plurality of time slots according to the request signals from each VOQ that has at least one awaiting cell;
c) at the sub-scheduling means that finishes the contention process, sending a contention result to each input means at every time slot; and
d) at the transfer-granted VOQ, transferring the cell to the switching means according to the contention result.

9. The method as recited in claim 8, wherein the each sub-scheduling means gives priority to each input means in the contention process to a same output.

10. The method as recited in claim 8, wherein each VOQ sends the request signal at every time slot by sending the number of cells waiting in the VOQ to the scheduling means.

11. The method as recited in claim 10, wherein the each sub-scheduling means gives a priority to a VOQ that has the largest number of awaiting cells in the VOQ in the contention process to the same output.

12. The method as recited in claim 10, wherein the each sub-scheduling means gives a priority to each VOQ in the contention process to the same output and gives a priority to a VOQ that has the largest number of awaiting cells in the VOQ when the VOQ that has the priority does not send the request signal.
